(19) United States
(12) Patent Application Publication
(10) Pub. No.: US 2019/0009169 A1
(43) Pub. Date: Jan. 10, 2019

(54) INTERACTIVE MEDIA-BASED CREATIVITY GAME SYSTEM WITH A PLAYING ACTIVITY PROGRESS CONTROLLED BY A PROCESSOR

(71) Applicant: Nir Kessler, Kfar Aviv (IL)

(72) Inventor: Nir Kessler, Kfar Aviv (IL)

(21) Appl. No.: 15/647,371

(22) Filed: Jul. 12, 2017

Related U.S. Application Data
(60) Provisional application No. 62/529,071, filed on Jul. 6, 2017.

(51) Int. Cl. A63F 9/00; G09B 19/22; G09B 5/02; A63F 9/06; A63H 33/04

(52) U.S. Cl. CPC A63F 9/0073; G09B 19/22; G09B 5/02; A63F 9/0602; H04L 65/4069; A63F 2250/50; A63F 2250/285; A63F 2250/287; A63H 33/042

(57) ABSTRACT

A game method includes receiving player preferences regarding a story represented as a digital media sequence. The story is chosen by the player, among a plurality of stories. The game method includes receiving a player's choice regarding a first digital media sequence comprising instruction for continuing the story, transmitting the first digital media sequence to a computerized device operated by the player, receiving a completion digital media sequence from an electronic device used by the player, indicating that the player has completed a mission, and transmitting another digital media sequence with another instruction to the computerized device operated by the player.

### FIELD OF THE INVENTION

The present invention relates to game sets based on digital media and a processor which guides players on the game sets. More specifically, the present invention discloses a method and a system which can receive indications on the course of the playing activities and provide with the guidance on how to proceed.

### BACKGROUND OF THE INVENTION

Assembly game sets comprising a number of structural parts designed to jointly create an imaginary structure have been played for many years in a self-contained fashion. The structural parts of the assembly game sets have a distinctive configuration comprises tiny wings and grooves on their surfaces utilized for interlocking the structural parts and thereby create a variety of buildings and structures. There is an enormous number of assembly game set types, starting with castles, buildings, imaginary environments, palaces, child rooms, up to open gardens, caves and more.

The numbers of the alternative assembly game sets providing optional ways to broaden the player's' imagine is large. However, the fairytale or the story associated with each particular assembly game set remains hidden. One of the limitations assembly game sets have is the inability to ignite enthusiasm in the players by involving the players with fairytales or legends associated with the structures of the assembly game set. Furthermore, assembly game sets are designed to be played independently, either by a single player, or by multiple players playing at the same location, without any option to receive a feedback or guidelines in real-time. In some cases, guidelines are provided in a written fashion with a technical format in order to instruct the players on how to assemble the structural parts, but these instructions cannot be interactively utilized during the playing activities.

Another aspect of the inflexibility characterizing the assembly game sets is the fact that the players can build new structures associated with stories and legends as they please. Yet, the players utilizing the assembly game sets conduct a continual process supported by the instructions of the manufacturer with not option to customize the guidelines and the story associated with the assembly game set, to the players' personal preferences.

### SUMMARY OF THE INVENTION

The current invention discloses a method operated by a processor for guiding players of in the courses of the playing activities. The assembly game set may comprise a collapsible structure designed to be built up in a number of optional structures and layouts, on a planar surface. In some cases, said structures and layouts may be a number of alternative designing's of the assembly game set parts which may be placed according to missions or tasks required to be accomplished by the players. Such missions or tasks may be provided to the player by the processor. In some other cases, the players can freely detect the playing activities and set the assembly game set parts in any desirable fashion. In some cases, the mission is to perform a task on a physical item, and wherein the completion digital media sequence documents the physical item after the task is performed by the player. Such physical item may be a puzzle, makeup on the player's face and the like.

Thus, in some cases, the processor may be configured to provide to the players' digital media sequences comprising guidance and guidelines to the missions or tasks the player may accomplish. In some cases, such guidance and guidelines may be explicit instructions on how to proceed with the playing activities. In some other cases, the guidance and guidelines may be incorporated into a story or play shown by the digital media sequences. In some cases, the players may need to conclude the guidance and guidelines from watching the digital media sequences. The processor can also be configured to incorporate story themes into the digital media sequence provided to the player. The digital media sequences provided by the processor or sent by the players can be a digital video file comprising a video content, or a file comprising a digital image (or images). In some other cases, the digital media sequence can be a video streaming streamed to or from the processor. In some cases, the story may be divided to multiple episodes, each of the multiple episodes ends with an instruction outputted to the player, for example using a video, audio or image sent from the processor to the player's computerized device. The method of the present invention uses a narrated story and missions that fit to the narrated story and requires the player's feedback in order to proceed to the next episode, thus providing a unique interactive playing experience.

The processor may also be configured to receive digital media sequences from a player playing with the assembly game set, wherein the digital media sequences may document the current layout of the assembly game set according to the missions or tasks required to be accomplished by the player. The processor may also be configured to analyze the received digital media sequence and identify whether the mission or the task which the player tries to accomplish, has been accomplished or not. In some cases, the processor may analyze the digital media sequence received form the player and then send back a digital media sequence comprising a guidance on how to proceed, according to the analysis of the digital media sequence.

In possible embodiments of the present invention, the processor may be configured to receive a self-picture of a player, in a digital format. The processor may also be configured to receive additional digitized material from the players. Such digitized material may be self-pictures, voice samples of players, preferred colors, preferred characters, and the like. The processor can also be configured to incorporate said received digitized material into the digital media sequence prepared for the player. For example, a player may send a self-picture by a mobile telephone to the processor. Then, the processor may incorporate the received picture to the guidelines of the missions or tasks provided to the player. In some cases, the guidelines conveyed to the players by the digital media sequence may be structured in episodes, wherein an episode comprises predefined guidance and guidelines for a specific course of playing activities.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A shows a lateral view of the collapsible assembly game set, according to exemplary embodiments of the present invention;

FIG. 1B shows an inner view of the collapsible assembly game set, according to exemplary embodiments of the present invention;

FIG. 1C shows a top view of the collapsible assembly game set, according to exemplary embodiments of the present invention;

FIG. 2 discloses the process of initiating a multi-episode mission game using an assembly game set, according to exemplary embodiments of the present invention;

FIG. 3 discloses a process for choosing a story among multiple options and start a multi-episode game of the chosen theme, according to exemplary embodiments of the present invention;

FIG. 4 defines the process of completing a mission by utilizing the episodes provided from the processor, according to exemplary embodiments of the present invention;

FIG. 5 discloses a software architecture of the processor, according to exemplary embodiments of the present invention;

FIG. 6 shows foldable structural parts designed to be part of an assembly game set, according to exemplary embodiments of the present invention, and;

FIG. 7 shows a spoke-hub structural part designed to connect multiple spokes in to one center, according to exemplary embodiments of the present invention.

### DETAILED DESCRIPTION OF THE INVENTION

The current invention discloses a 3-dimensional assembly game set comprising a collapsible structure designed to be built up, by playing activities, in a number of optional structures and layouts onto a planar surface. The 3-dimensional assembly game set can also be used by a player to accomplish missions or tasks provided and conducted by a processor. In some cases, said missions or tasks, may be accomplished according to episodes. The collapsible structure of the assembly game set may comprise structural parts which the player utilized in the playing activities. Such structural parts may be building components such as side walls, bottom panels, top walls, walls with apertures, rigid walls designed to hold structures, pillars, columns, planer surfaces, and the like. In possible embodiments of the present invention, the game set may also comprise game accessories such as rails, houses, plastic games, trees, dolls, game animals, game figures, small construction models, vehicles of various types and sizes and the like. In some cases, the missions or tasks accomplished by the player may be to build certain layouts by the structural parts of the assembly game set, to identify an element on the planer surface of the collapsible structure, to place tools or game accessories on a structure, and the like.

The processor of the assembly game set can be configured to receive a content documenting the layout according to a completion of a mission or task by the player. The content may comprise an image or a digital media which show at least one element of the assembly game set layout. The processor can also analyze the content to determine whether the mission was completed properly, and provide to the player another episode comprising guidelines on how to complete another mission. The content received by the processor can be provided by a player in a form of a media file, such as a digital photo or a digital video. For example, a player operating a computerized device such a mobile telephone may record the process of completing the mission or an image of the completed mission and send the digital video to the processor. The processor may analyze the content from the player, out of the received digital photo and send back another episode and guidelines of that episode. In some cases, the episodes may be sent to the player's computerized device.

In some embodiments of the present invention an episode provided to the player may be a part of an episode sequence. In some cases, the episode prepared by the processor may also be corresponding to the playing activities progress of the player. For example, a player sends a digital media sequence documenting the current layout resulting of some playing activities took place according to the episodes provided by the processor. The processor may receive the documented layout sent by the player and then send back to the player the next episode in an episode sequence. In some cases, episode may relate to a partial layout of a final layout or structure the players may complete may. In such cases, the player may receive missions and tasks which guide the player on how to complete the final layout or structure.

In some cases, an episode sequence may also be associated with a story comprising details, questions, problems to solve and the like, which may embed the guidelines for the playing activities. For example, playing activities of a final layout or structure may be associated with a story of a group of children saving the day. Thus, the episodes of the story associated with the playing activities may start with a short digital movie showing the adventures of a group of children. In some cases, the guidelines embedded in an episode may be told by one or more children of the group. The final layout or structure which the players may complete may be any structure or setting of the structural parts and/or the game accessories which the assembly game set comprises.

In some embodiments of the present invention the processor may also be configured to incorporate digital images associated with the players, into the guidance provided to the player. For example, a player can picture a self-image and send the image to the processor, the processor may send back the guidance on how to proceed with the playing activities, wherein the self-image sent by the player may be incorporated in the guidance. In some cases, the guidance prepared by the processor may be a digital media sequence, or digital images which comprise the guidance on how to continue with the playing activities. In some cases, the guidance may be a distinct set of instructions for the players. In some other cases, the guidance may comprise some optional scenarios which the player can utilize and play accordingly.

In some embodiments of the present invention the guidance for the playing activities may require a recording of the assembly game set and document the layout of the playing activities. For example, a player may receive a guidance or optional scenarios to follow, the player may follow the scenario or the guidance, and record the completed layout of the game set with a computerized device. The player may also send the recorded documentation to the processor, and upon sending the documentation the player may receive the corresponding digital media sequence, or digital images which provide the guidance on how to proceed with the playing activities. In such cases, the player may be enthused and encouraged to proceed to the next episode

In some embodiments of the present invention the player may be suggested to choose a level of difficulty for the playing activities. In some cases, the player may be asked to choose the difficulty level in early step of the playing. For example, a player may start playing with an assembly game set and provide the processor the desirable difficulty level for the entire play. In some other cases, the player may be provided with an option to change the difficulty level during the play. For example, in optional embodiment of the invention, a player may be asked to choose the difficulty level in case of a new guidance provided to the player. In some cases, wherein the guidance may comprise a plurality of optional scenarios which the player can utilize and play accordingly, the optional scenarios may be categorized in diverse difficulty levels.

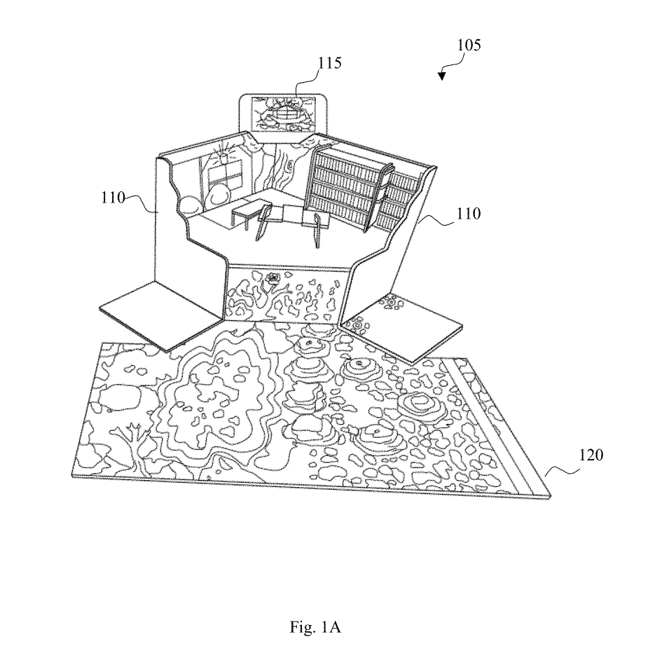

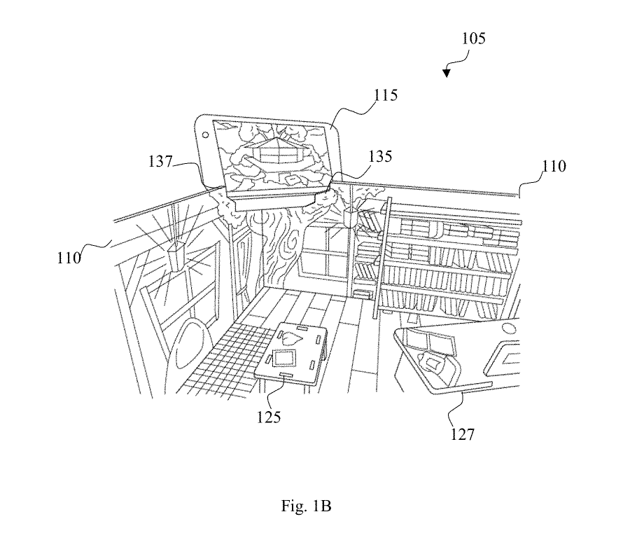

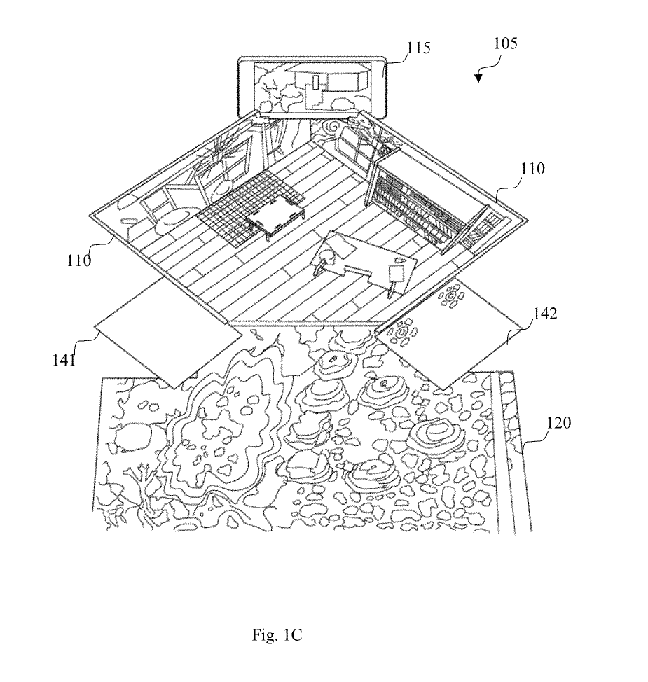

FIG. 1A shows a lateral view of the collapsible assembly game set, according to exemplary embodiments of the present invention. FIG. 1A shows an assembly game set 105 which may be built by at least one player. The assembly game set 105 comprises a peripheral wall 110 which may be one of the main structural part surrounding an inner content of a child room. The peripheral wall 110 may be a collapsible structural part which can be folded and inserted into a box. The assembly game set 105 also comprises surface planner 120 which can be an integral structural part of the main structure. FIG. 1A also shows a mobile telephone device 115 located at the top rim of the wall. The mobile telephone device 115 can be used to record the playing activity progress of the assembly game set 105, send the digital media sequence to a processor, and then, receive the guidelines for the next phase. In some cases, the next phase may be an episode sent to the player's computerized device and comprises a digital media sequence. In some embodiments of the present invention, the mobile telephone device 115 may be mounted on a dedicated device capable of rotate or move along the play and record objects which were laid by the player. FIG. 1B shows an inner view of the collapsible assembly game set, according to exemplary embodiments of the present invention. FIG. 1B shows an assembly game set 105 which may be built by at least one player. The assembly game set 105 comprises a peripheral wall 110 which may be one of the main structural parts surrounding an inner content of a child room. The inner content resides in the peripheral wall 110 comprises multiple game accessories such as table 125 and desk 127 which may be part of the assembly game set 105. The peripheral wall 110 may also comprise a left socket 137 and a right socket 135 designed to contain a mobile telephone device such as mobile telephone device 115. The mobile telephone device 115 can be located at the top rim of the wall, within the right socket 135 and the left socket 137, situated in a position which can record the completion of a mission, for example placing objects on the peripheral wall 110. Thus, the mobile telephone device 115 can be used to record the completion of the mission, sends the digital media sequence to a processor, and then, receives the digital media sequence of the next episode and the guidance of the next mission.

FIG. 1C shows a top view of the collapsible assembly game set, according to exemplary embodiments of the present invention. FIG. 1C shows an assembly game set 105 which may be built by at least one player. The assembly game set 105 comprises a peripheral wall 110 which may be one of the main structural part surrounding an inner content of a child room. The peripheral wall 110 may be a collapsible structural part which can be folded and inserted into a box. The assembly game set 105 also comprises surface planner 120 which can be an integral structural part of the main structure. FIG. 1C also shows a mobile telephone device 115 located at the top rim of the wall. The mobile telephone device 115 can be used to record the layout resulting by the playing activity with the assembly game set 105, send the digital media sequence to a processor, and then, receive guidelines for the next episode. In some cases, the digital media sequence may be sent to another computerized device, which may not be the computerized device from which the image or video was sent to the processor. In some other cases, a camera may be located instead of the mobile telephone device 115. The peripheral wall 110 also comprises a bottom panel 141 and bottom panel 142. The bottom panels 141 and 142 can be used to close the collapsible assembly game set 105 in case the assembly game set 105 is inserted into a box. In such cases, the bottom panels 141 and 142 can function as a lid of the assembly game set 105. In some other cases, the bottom panels 141 and 142 may also be used in the playing activities and function as structural parts. For example, bottom panels 141 and 142 can be used as two planner surfaces.

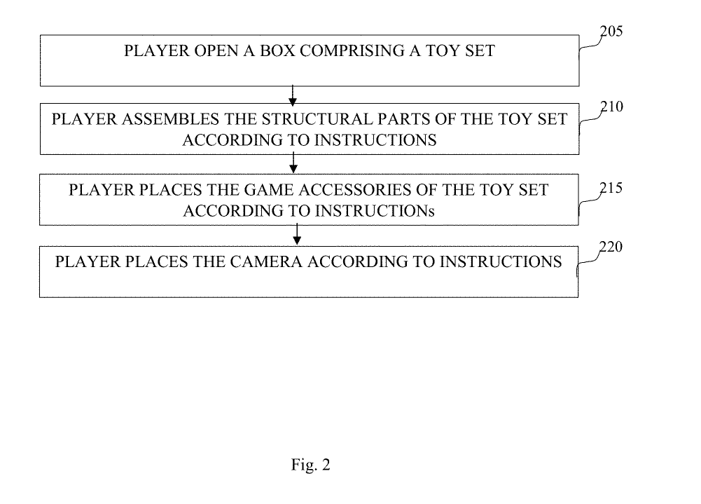

FIG. 2 discloses a process of initiating a multi-episode mission game using an assembly game set, according to exemplary embodiments of the present invention. In step 205 a player opens a box comprising the collapsible structure of the assembly game set. In some cases, the box may also comprise additional parts such as structural parts, and/or game accessories which may be added to the structure. In step 210 the player may start to build a structure out of the structural parts. For example, a player may take the side walls out of the box, fold up outwardly the side walls and locate the folded side walls on a planer surface. In some cases, the structural parts may be provided in a distinctive configuration comprising grooves and tiny wings, holes, and the like, on their surfaces utilized for interlocking the structural parts. For example, a first sidewall may comprise grooves at the sides of the sidewall, and a second sidewall may comprise tiny wings which can be inserted into the first sidewall and thereby interlocking the two sidewalls.

The guidelines for initiating the playing activities may be provided in a written format to the player. In some cases, the player may be able to picture or record the layout of the assembly game set resulting of the playing activities, send the digital content to the processor and then receive back the guidelines for the first episode. In some cases, the guidelines for the player may be provided in a format of a digital movie which can be operated on a mobile computerized device such as mobile telephone, tablet personal computer, a personal computer, a computerized system utilizing processing units, or any other machine capable of automatically operating a programmable series of actions which are also capable of operating digital content of a video or digital pictures. In step 215 the player places game accessories on the structure. In some cases, the player may locate some game accessories out of the structure, for example, in the planer surface situated beneath or at the side of the structure. In step 220 the player places a camera at the vicinity of the structure which is currently being built. In some other cases, the camera may be connected to a computerized system utilizing processing units, or any other machine capable of automatically operating a programmable series of actions which are also capable of taking digital pictures. In some embodiments of the present invention, the structural parts may comprise a dedicated holder designed to hold a computerized mobile device. In such cases, the player may insert the computerized mobile device into the holder and operate the camera.

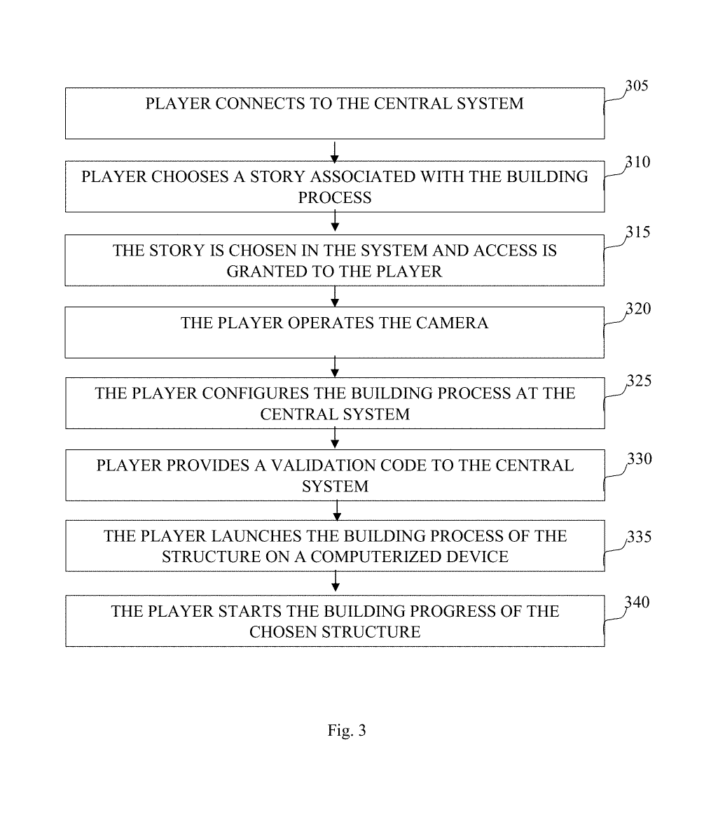

FIG. 3 discloses a process for choosing a story among multiple options and start a multi-episode game of the chosen theme, according to exemplary embodiments of the present invention. In step 305 the player connects to the processor in order to start the game. The connection to the processor may be conducted by a dedicated application operated on the player's computerized device and utilized to communicate with the processor. The processor may be operated on a server connected to the internet, or in some cases, to a telecommunication network such as LAN, WAN and the like. In some cases, the player may be asked to enter a name or a username which may be utilized during the playing activities. In some other cases, the player may undergo a registration or/and a log-in process to approve the player's identity. In some embodiments of the present invention, the processor may be configured to operate a two-factor authentication process in order to approve the identity of the player. For example, the processor may send a text message with a validation code to the mobile device of the player. The player may be required to insert the received validation code in the interface utilized to connect to the processor.

In step 310 the player receives from the processor a menu with a list of optional stories. In some cases, the story may comprise some episodes comprising embedded guidelines for the game. In step 315 the player is granted with a permission to start the game according to guidelines provided though the episodes. In step 320 the player operates the camera which may be utilized during the game. The camera can be utilized to record the completed mission in a digital format such as a video movie or a picture. The camera can also be connected to a computerized device configured to communicate with the processor in order to transmit to the processor the digital documentation of the mission. In some cases, after the log-in part disclosed in step 305, the player may be required to operate the camera utilized to record the digital video of the playing activities.

In step 325 the player may configure the view properties of the screen showing the content received from the processor. Such view properties can define the outer look of the application utilized to communicate with the processor. For example, the player may be able to choose the fonts in the screen, the theme of the outer look of the application, to change the background, the colors, the language of the application, and the like.

Step 330 is an optional step in which the player may provide a validation code utilized to validate the legitimacy of the assembly game set held by the player. In some cases, the player may need to provide a code written on the assembly game set, or the assembly game set's box. In some other cases, the player may scan a barcode which appears on the assembly game set, or the assembly game set's box. In some cases, the player may provide a code received via a text message, or sent via mail. In some embodiments of the present invention, step 330 may take place before step 315. Thus, the code validation described in step 330 may occur before the permission granting described in step 315.

In step 335 the player may launch the game by displaying the digital media sequence provided from the processor, at the display of the mobile device. The player's device receiving the digital media sequence can obtain the guidelines of the next mission from the video display. In some cases, the guidelines may be embedded in episodes according to the story chosen in step 310.

In some embodiments of the present invention, music, visual effects, colors may be added to the digital media sequence, and/or to the episodes shown on the display device. The digital media sequence, and/or to the episodes utilized to guide the player through playing activity progress may also show characters which can narrate at the language chosen by the player. The characters may narrate the guidelines to the player, such that the player may be able to follow the guidelines during the game. In some cases, the characters shown in the digital media sequence, and/or in the episodes may be imaginary characters which were predefined in the processor. In some other cases, the characters may be famous characters which are known to any average person who utilize the assembly game set.

In some embodiments of the present invention, the player may be able to send a self-picture in a digital format from a computerized device to the processor. The processor may be configured to utilize the self-picture in the episodes and the self-picture may participate in some parts of the episodes. In some cases, the self-picture may become the narrator of the episodes in the theme. In some cases, the player may also be able to send a voice sample which can be used by the processor for the narrating. For example, a player utilizes the dedicated application for communicating with the processor can send a self-picture and a voice sample to the processor and then receive an episode showing a character based on the self-picture and a narrator which has a voice taken from the voice sample sent by the player. The processor is configured to select an audio file to be sent to the player's computerized device according to a language selected by the player. In some cases, the language may be selected automatically according to a property of the player's computerized device, for example the device location, device type and the like. In step 340 the player uses the structural parts and the game accessories to complete the mission according to the guidelines in the episodes provided by the processor.

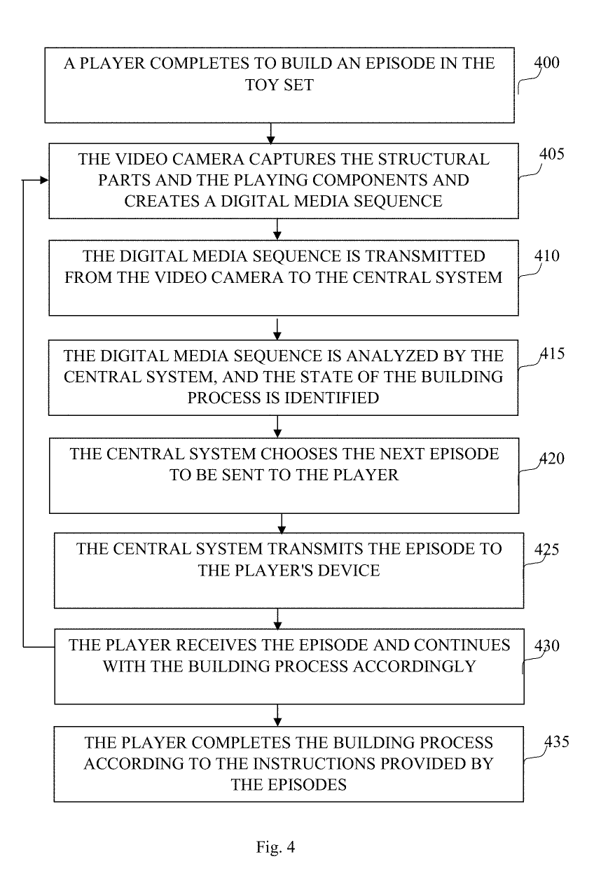

FIG. 4 defines the process of completing a mission by utilizing the episodes provided from the processor, according to exemplary embodiments of the present invention. In step 400 a player completes the mission of an episode. Such an episode may embed the guidelines of the mission according to a certain story/theme chosen by the player. In step 405 a camera operated by the player records the layout associated with the mission. Such a layout may be structural parts and game accessories of the assembly game set. Said camera may be connected to a computerized device for processing the digital media sequence creation and transmitting to the processor.

In step 410 the digital media sequence may be transmitted from the device connected to the camera, to the processor. In step 415 the digital media sequence is analyzed by the processor, which determines whether the mission has been completed or not. In some cases the digital media sequence analysis may not take place and the mission may be defined as completed once the player provides a digital media sequence as a response to receiving of a mission guidelines from the processor. In some cases, the processor may be configured to identify the specific episode the player has completed, and thereby identify the next episode the player shall receive.

In step 420 the processor choses the next episode to be sent to the player. In some cases, the processor may also embed the self-picture of the player or/and the voice of the player into the episode. For example, the processor may add a character based on the player's self-picture to the episode. In some cases, the character can be made of the self-picture, and in some other cases, the character can be a graphic character converted from the self-picture, or from any other image such as doll image, a statue, an art artifact, a game, and the like. The converted graphic character can be, an animated character of the player, a self-picture with additional filters such as blur, light and shadow, a noise cleaner, and the like. In some cases, the converted graphic character may also comprise a decoration and other decorative elements added by the processor.

In step 425 the processor may transmit the episode which may comprise the guidelines to the player. In some cases, the episode may be transmitted to the computerized device connected to the camera. In some other cases, the episode may be transmitted to another computerized device which may not be connected to the camera. For example, a player may utilize a computerized mobile device to record the layout of a completed mission and to transmit the digital video sequence to the processor. In such a case, another computerized device which may not necessarily be connected to the camera to receive the episodes. In step 430 the player may watch the received episode and conclude the guidelines for the next step, out of the occurrences in the episode. For example, the episode may show a team of people completing a mission. The mission and the explanations on the mission requirements may indicate about the steps required to proceed with the playing activities.

Once the player completes the layout according to the mission in the received episode, in case the completed episodes is the last episode which completes the final layout, the player may go to step 435. In step 435 the game terminates. In some cases, the final layout may be the final structure or the target layout the players should accomplish with the assembly game set. For example, the final layout may be a castle with the royal family playing at the yard outside of the castle. Thus, the episodes provided to the players may comprise missions and tasks which guide and assist the players to reach the final layout. The players may be able to conduct the playing activities in order to accomplish the missions and tasks, by utilizing the structural parts and/or the game accessories of the assembly game set. In some cases, the player may be able to record some completed missions and send to the central device.

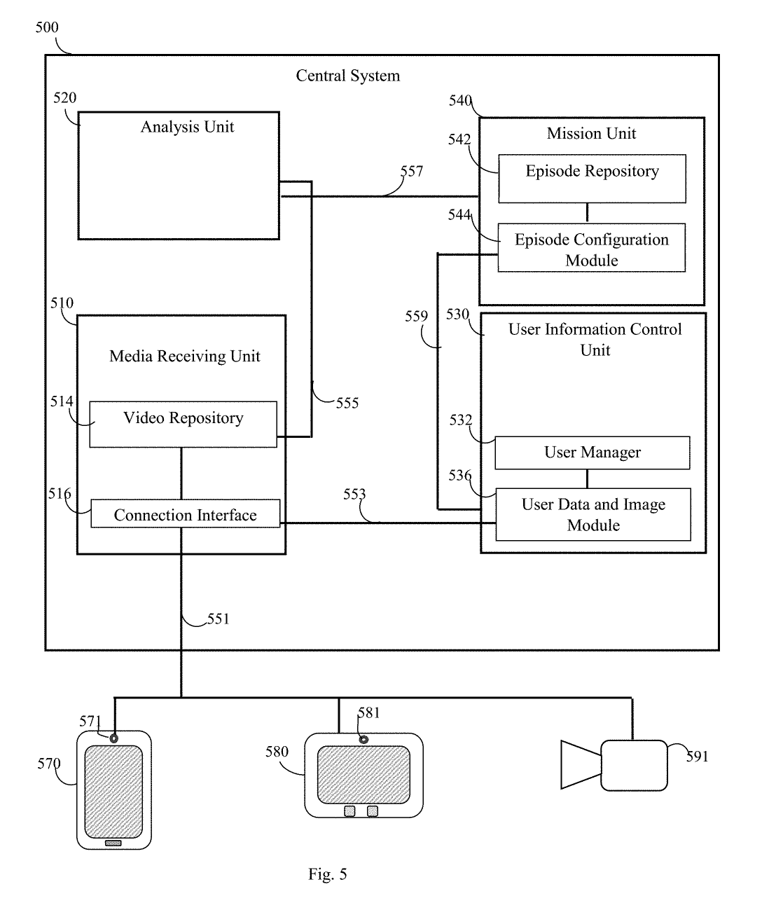

FIG. 5 discloses a software architecture of the processor, according to exemplary embodiments of the present invention. FIG. 5 shows a processor 500 comprising media receiving unit 510, analysis unit 520, mission unit 540, and player information control unit 530. The processor 500 may be an implementation of a software program designed to control the playing activities of multiple players. Thus, the processor 500 may be configured to simultaneously receive digital media sequences from multiple computerized devices operated by players, and analyze the received images or videos in order to identify the specific episodes appearing in the received digital media sequences. The architecture of processor 500 may be implemented in a software program can be operated by a server, a computerized device, a cluster of servers or at least one virtual server configured to operate the processor 500. The processor 500 can also be connected via connection 551 to computerized devices or cameras. In some cases, the computerized devices can be such as computerized mobile phone 570 which utilizes camera 571, tablet personal computer 580 utilizes camera 581. In some other cases, the computerized devices can be such as camera 591 which in some cases may be connected to another computerized device configured to receive the digital media sequence and convey said video sequence to the processor 500.

The processor 500 can be configured to manage the connections with the computerized devices by the media receiving unit 510. The media receiving unit 510 can control the communication processes with the computerized devices and receive the digital media sequences sent by the players. The media receiving unit 510 may comprise a connection interface 516 which may be a player interface designed to accept communication from players wanting to register, log-in, upload digital media sequences, and the like. In some cases, the connection interface 516 may also be configured to associate the digital media sequences with the names of the players which transmitted said digital media sequences. The connection interface 516 may also be configured to provide the players with the episodes related to the player's playing activities. In some cases, a player may have more than one connection to the media receiving unit 510. For example, a player may have one computerized device for recording the completed missions and uploading the digital media sequence to the processor 500 and another computerized device for receiving the episodes from the media receiving unit 510.

The media receiving unit 510 may also comprise a media repository 514 designed to receive the digital media sequences and images sent by the players. For example, a player may record the layout resulting of some playing activities by a camera, and send the digital media sequence to the media receiving unit 510 via connection 551. The media receiving unit 510 may store the digital media sequence in the media repository 514. The media repository 514 may utilize the connection 555 to communicate with the analysis unit 520 to transmit the digital media sequences received from players.

In some embodiments of the present invention, the analysis unit 520 may be configured to conclude the individual state of the mission as it may be recorded in the digital media sequence associated with a player. The analysis unit 520 may be configured to identify the specific episode and the structural parts used in the mission associated with that episode, and thereby to conclude whether the player has completed the episode or not. In some cases, concluding the missions in a specific episode may utilize some computerized procedures implementing methods from the field of Image analysis. Such methods can be pattern recognition, object recognition and the like. In other cases, these methods can combine utilization of labels printed or sometime coined on the structural parts. For example, the analysis unit 520 may utilize object recognition methods for identifying specific structural parts related to the episode, in digital images or a video sequence provided by a player.

In some cases, the analysis unit 520 may be configured to recognize the structural parts despite the fact that the structural parts, in the digital media sequence, may vary somewhat in different viewpoints, or angles. In some cases, the analysis unit 520 may be configured to recognize the structural parts despite the fact that the structural parts displayed in the digital media sequence, may vary at different viewpoints, or angles.

The mission unit 540 of the processor 500 can comprise an episode repository 542 designed to store a variety of predefined episodes. The mission unit 540 can communicate with the analyst unit 520 via connection 557 and receive the name of the episode the player tries to accomplish. The mission unit 540 may also comprise an episode configuration module 544 designed to configure the next episode to a specific player. The episode configuration module 544 can receive from analyst unit 520 the details on the specific episode the player tries to accomplish and the status whether the player has accomplished the episode, or not. According to the details received from the analyst unit 520 the episode configuration module 544 can create the next episode for the player. The episode configuration module 544 may communicate with the player information control unit 530, via connection 559, and receive the properties of the episode the player tries to accomplish. The properties of the episode may be such as the player's name or identification, the episode the player tries to accomplish, the story the episode is associated with, images and photos the player may upload to the processor 500, sound, color, theme of the story, and the like.

The episode configuration module 544 may be able to process the episode properties and create the next episode for the player, in such a case wherein a new episode is required (e.g. in case the player has accomplished an episode). The episode configuration module 544 can communicate with the episode repository 542 identify the next episode for the player and on the basis of the identified episode create a customized episode for the player. The customization of the episode configuration module 544 can be such as adding colors, adding visual effects according to the player prelaminar choices, adding narration at the voice of the player, adding an opening session to the episode comprising an image of the player, and the like. Once the episode is configured and customized by the episode configuration module 544, the episode configuration module 544 can transmit the completed episode via connection 559 to the player information control 530 which may store the newly created episode in the player data and image module 536.

The player data and image module 536 which may be a part of player information control 530, may be configured to store the player data and images. For example, the player may have an option provided by the connection interface 516 to upload self-images which can be embedded in the episodes. Thus, the player may upload an image which may be transmitted from the connection interface 516, via connection 553 and be stored in the player data and image module 536. In some cases, the player data and image module 536 may also comprise voice samples of the players. The player data and image module 536 may also be configured to communicate with the episode configuration module 544 and receive and store newly created episodes associated with the players. The player data and image module 536 can also communicate with the connection interface 516 and transmit newly created episodes associated with players in order to send the episodes further to the players.

The player data and image module 536 may also be configured to communicate with the player manager 532 which may also be a part of the player information control 530. The player manager 532 may comprise the registered players. In some cases, the player manager 532 may also comprise the nickname of the players and specific details about the players. The specific details of the players may be such as, the last time the player has connected to the processor 500, the theme chosen by the player, the story chosen by the player, the them, the colors, and the like.

In some embodiments of the present invention the connections used in the processor 500 may be physical connections. For example, in case the processor is configured to be operated by more than one server, connections such as connections 553, 555, 559, and the like, may be physical connections. Such physical connection can be an optical fiber connection, wire connection, and the like. In some other cases, wherein the processor 500 may be operated by one server, or once computerized device, the connections such as connections 553, 555, 559, and the like, may be software interface based connection. For example, the connection 557 may be based on reading and writing to shared memory buffers. In some cases, the processor 500 may comprise application programming interface utilized to communicate between the modules.

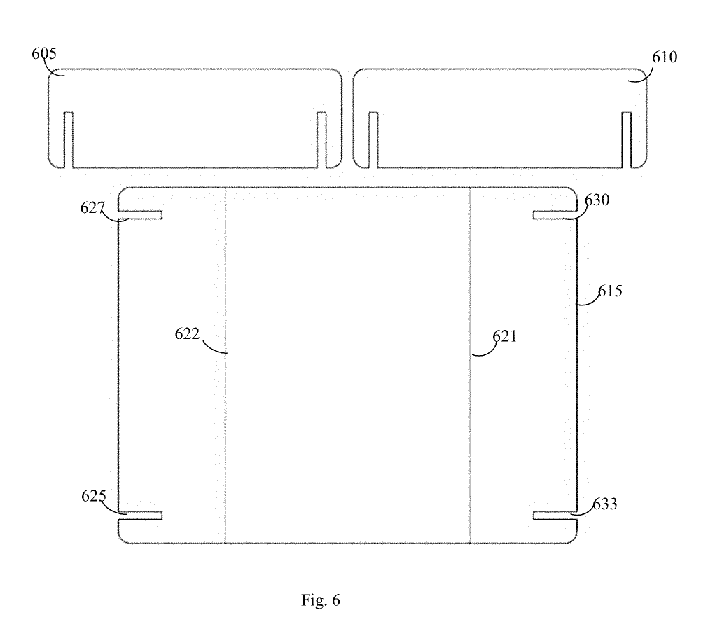

FIG. 6 shows foldable structural parts designed to be part of an assembly game set, according to exemplary embodiments of the present invention. FIG. 6 shows foldable structural parts, 605, 610 and 615 designed to be mounted with other foldable structural parts. Foldable structural part 615 comprises a folding line 621 and a folding line 622. The folding lines 621 and 622 can mark the place wherein the foldable structural part 615 may be folded. For example, a player can fold the structural part 615 such that the left part of the foldable part 615, residing to the left of the folding line 622 may fold up and situated in a ninety degree to the middle part of the foldable part 615, residing between folding line 622 and folding line 621. Similarly, a player can fold the folded structural part 615 such that the right part of the foldable structural part 615, residing to the right of the folding line 621 may fold up and situated in a ninety degree to the middle part of the foldable structural part 615 residing between folding line 622 and folding line 621. Foldable structural part 615 also comprise connection grooves 625, 627, 630, and 633. The connection grooves may be utilized to connect the foldable structural part 615 with other structural parts. In some cases, another structural part may comprise tiny wings, or pins designed to connect to the connection grooves 625, 627, 630, and 633.

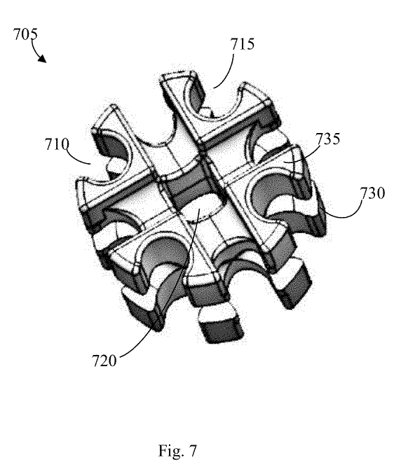

FIG. 7 shows a spoke-hub structural part designed to connect multiple spokes in to one center, according to exemplary embodiments of the present invention. FIG. 7 shows a spoke-hub 705 designed to connect multiple spokes in to one center in order to reinforce the structure being built by the player (or players). The spoke-hub 705 comprises an upper spoke-hub 735 and a lower spoke-hub 730. In some cases, different spokes may be connected to different spoke-hubs. For example, in some cases, spokes can be connected to the upper spoke-hub 735, and other spokes can be connected to the lower spoke-hub 730. The spoke-hub 705 also comprise a hole 720 designed to receive a rod (not shown) or a spoke which can be threaded into the hole 720. In some cases, such a rod may also be connected to other structural parts such as walls, peripheral walls, columns, and the like. The spoke-hub 705 also comprise a plurality of sockets designed to accept the spokes connected to the spoke-hub 705. For example, spokes can be threaded to sockets 710, and/or to socket 715. Sockets 710, and 715 can fasten the threaded spokes such that the spokes may not be able to slip out or remain loosen. The spokes threaded into sockets 710, and 715 may be connected in the other side of the spokes to other spokes, or spoke-hubs. In some cases, the spokes may be connected to other structural parts such as walls, surface planners, and the like, in order to reinforce the structure being built.

In some embodiments of the present invention the structural parts of the assembly game set may be provided with diverse colors and hues. In some cases, the colors and the hue may be functional elements in the playing activities. The functional elements may be such as, dedicated colors or shapes indicating the structural parts colored in that color (or shape) have a special functionality. For example, dedicated colors (or shape) indicating the structural parts colored in that color may be placed in specific place at the final layout, dedicated colors (or shape) indicating the structural parts colored in that color may be used at a special phase of the playing activities, and the like.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method operated by a processor, comprising:
receiving player preferences regarding a story represented as a digital media sequence, wherein the story is chosen by the player, among a plurality of stories;
receiving a player's choice regarding a first digital media sequence comprising instructions for continuing the story;
transmitting the first digital media sequence to a computerized device operated by the player;
receiving a completion digital media sequence from an electronic device used by the player, wherein said completion digital media sequence indicates that the player has completed a mission;
transmitting another digital media sequence to the computerized device operated by the player, said another digital media sequence comprises another instruction.

2. The method of claim 1, wherein the another digital media sequence is compatible with the progress of the playing activities of the player.

3. The method of claim 1, wherein the mission is to perform a task on a physical item, and wherein the completion digital media sequence documents the physical item after the task is performed by the player.

4. The method of claim 3, wherein the completion digital media sequence is embedded in the digital media sequence transmitted to the computerized device.

5. The method of claim 1, further comprises analyzing the completion digital media sequence and identifying the specific layout resulting of the playing activities of the player.

6. The method of claim 5, wherein identifying the specific layout resulting of the playing activities is done according to whether the player has completed or has not completed an episode, wherein an episode comprises predefined instructions.

7. The method of claim 1, further comprises customizing the first digital media sequence according to the player's preferences regarding the story.

8. The method of claim 7, wherein customizing the first digital media sequence comprises embedding a self-picture of the player into the first digital media sequence.

9. The method of claim 7, wherein customizing the first digital media sequence comprises embedding a narration with the voice of the player into the first digital media sequence.

10. The method of claim 7, wherein customizing the second digital media sequence comprises embedding a narration in the preferred language of the player into the first digital media sequence.

11. The method of claim 1, further comprises receiving a selection from the player's computerized device, wherein the player selects a first digital media sequence is among a plurality of optional first digital media sequences.

12. A processor designed to operate a computerized operable method, comprising:
a connection interface designed to:
(i) receive player preferences regarding a theme of a digital media sequence, wherein the theme is chosen by the player, among a plurality of themes presented to the player by a media receiving unit,
(ii) receive a completion digital media sequence from a player, wherein said completion digital media sequence indicates that the player completed a mission;
a mission unit designed to:
(i) choose a first digital media sequence comprising instructions for continuing the theme;
(ii) customize the first digital media sequence according to the player preferences regarding the theme;
and wherein the connection interface is also configured to transmit the first digital video to a computerized device operated by the player.

13. The processor of claim 12, wherein the connection interface is configured to receive video content in a format of a digital file.

14. The processor of claim 12, wherein the connection interface is configured to receive video content in a format of a video streaming.

15. The processor of claim 12, further comprises an analysis unit designed to analyze the completion digital media sequence and identify whether the mission was complete or not.

16. The processor of claim 12, wherein the mission is to perform a task on a physical item, and wherein the completion digital media sequence documents the physical item after the task is performed by the player.
